(19) United States
(12) Patent Application Publication
(10) Pub. No.: US 2013/0057910 A1
(43) Pub. Date: Mar. 7, 2013

(54) IMAGE FORMING APPARATUS MANAGEMENT SYSTEM, MANAGEMENT APPARATUS, IMAGE FORMING APPARATUS MANAGEMENT METHOD, AND RECORDING MEDIUM

(71) Applicant: Tetsuya Matsumoto, Kawasaki-shi (JP)

(72) Inventor: Tetsuya Matsumoto, Kawasaki-shi (JP)

(73) Assignee: CANON KABUSHIKI KAISHA, Tokyo (JP)

(21) Appl. No.: 13/596,741

(22) Filed: Aug. 28, 2012

(30) Foreign Application Priority Data
Sep. 6, 2011 (JP) 2011-194107

(51) Int. Cl. G06K 15/02

(52) U.S. Cl. 358/1.15

(57) ABSTRACT

The image forming apparatus management system includes type decision means for determining the type of the user terminal as a notification target, based on movement frequency of the user terminal; notification target decision means for determining which user terminal is likely to be using each of the image forming apparatuses, based on position information on the user terminal and position information on the image forming apparatus, according to the type of the user terminal determined by the type decision means, and thereby judging the user terminal that is likely to be using the image forming apparatus, as a notification target to be notified of a power status of the image forming apparatus; and power status notification means for sending power status notification to the user terminal judged as the notification target, when the power status of the image forming apparatus is changed.

### BACKGROUND OF THE INVENTION

1. Field of the Invention

The present invention relates to an image forming apparatus management system for providing notification of a power status of an image forming apparatus, a management apparatus, an image forming apparatus management method, and a recording medium. More particularly, the present invention relates to an image forming apparatus management system for reducing power consumption by controlling a power supply of an image forming apparatus, a management apparatus, an image forming apparatus management method, and a recording medium.

2. Description of the Related Art

Heretofore, companies have been required to save and cut down costs, and, in recent years in particular, they also have been required to reduce the amount of power consumed when using image forming apparatuses such as printers and multi-function printers. One method for reducing power consumption is to power off the image forming apparatuses at time periods while the apparatuses are not being used, to transition the image forming apparatuses to power saving mode in which standby power is lowered with their functions limited, or to do the like. Japanese Patent Laid-Open No. 2009-107167, for example, discloses technology for switching between operation modes (e.g. active mode and power saving mode) in accordance with the number of image forming apparatuses in the active mode. According to this technology, a larger number of image forming apparatuses than necessary can be prevented from becoming active at a time, so that the amount of power consumed can be reduced.

Meanwhile, in recent years, there have also been various proposals of technologies in which: image forming apparatuses and user terminals are provided with high-accuracy GPS (global positioning system) devices, the relative positions of the apparatuses and the terminals are recognized by using high-accuracy position information. Such technologies are effective particularly in non-territorial office environments (i.e. environments where users change their desks every day or at intervals of a few hours) and the like, because an image forming apparatus close to a user can be automatically selected to produce output.

However, with an apparatus described in Japanese Patent Laid-Open No. 2009-107167, even if the system keeps track of which image forming apparatus is in the active mode, a user himself or herself who is an actual user of the image forming apparatuses cannot judge when and which image forming apparatus is available or unavailable. To address this situation, the applicant of the present invention contemplates utilizing GPS-based or other position information to provide users near an image forming apparatus with a notification of a change of power status of the apparatus. However, when the notification of the change of power status is simply provided to user terminals within a certain distance from the image forming apparatus, a problem exists that the notification is delivered to even user terminals which are not actually using the image forming apparatus thus notified.

The present invention has been made inconsideration of the foregoing problems. An objective of the present invention is to provide an image forming apparatus management system capable of sending an appropriate user terminal notification of a change of power status of an image forming apparatus when the power status is changed, a management apparatus, an image forming apparatus management method, and a recording medium.

### SUMMARY OF THE INVENTION

In order to attain the above objective, there is provided an image forming apparatus management system including plural image forming apparatuses connected to a network, and plural user terminals which each use anyone of the plural image forming apparatuses connected to the network, including: type decision means for determining the type of each of the user terminals as a notification target, based on movement frequency of the user terminal; notification target decision means for determining which user terminal is likely to be using each of the image forming apparatuses, based on position information on the user terminal and position information on the image forming apparatus, according to the type of the user terminal determined by the type decision means, and thereby judging the user terminal that is likely to be using the image forming apparatus, as a notification target to be notified of a power status of the image forming apparatus; and power status notification means for sending power status notification to the user terminal judged as the notification target by the notification target decision means, when the power status of the image forming apparatus is changed.

According to the present invention, it is possible to provide an image forming apparatus management system capable of sending notification of a change of power status of an image forming apparatus to an appropriate user terminal when the power status is changed, a management apparatus, an image forming apparatus management method, and a recording medium.

Further features of the present invention will become apparent from the following description of exemplary embodiments (with reference to the attached drawings).

### BRIEF DESCRIPTION OF THE DRAWINGS

FIG. 1 is a schematic representation showing a configuration of an image forming apparatus management system showing an embodiment of the present invention;

FIG. 2 is a block diagram showing an example of an internal configuration of an information processing apparatus which forms a client computer 101, a mobile terminal 102 and a management server 105 of the embodiment;

FIG. 3 is a block diagram showing an example of an internal configuration of a multi-function printer 104 of the embodiment;

FIG. 4 is a block diagram showing an example of a functional configuration of the client computer 101 and the mobile terminal 102;

FIG. 5 is a block diagram showing an example of a functional configuration of the management server 105;

FIG. 6 is a block diagram showing an example of a data processing configuration of the multi-function printer 104;

FIG. 7 is a table showing an example of a table included in an image forming apparatus information management unit 502;

FIG. 8 is a table showing an example of a table included in the image forming apparatus information management unit 502;

FIG. 9 is a table showing an example of a table included in a user terminal information management unit 503;

FIG. 10 is a table showing an example of a table included in the user terminal information management unit 503;

FIG. 11 is a table showing an example of a job log table of the embodiment;

FIG. 12 is a table showing an example of an analytical result table;

FIG. 13 is a table showing an example of an analytical result table;

FIG. 14 is a flowchart showing an example of a processing procedure for a power status notification process;

FIG. 15 is a view showing a relationship among FIG. 15A, FIG. 15B and FIG. 15C;

FIG. 15A is a flowchart showing an example of a processing procedure for a notification target decision process;

FIG. 15B is a flowchart showing an example of a processing procedure for a notification target decision process;

FIG. 15C is a flowchart showing an example of a processing procedure for a notification target decision process;

FIG. 16 is a view showing a relationship between FIG. 16A and FIG. 16B;

FIG. 16A is a flowchart showing an example of a processing procedure for a notification content setting process;

FIG. 16B is a flowchart showing an example of a processing procedure for a notification content setting process;

FIG. 17 is a representation showing an example of power-off notification of power status change notification of the embodiment; and

FIG. 18 is a representation showing an example of power-on notification of the power status change notification of the embodiment.

### DESCRIPTION OF THE EMBODIMENTS

Best modes for carrying out the present invention will be described below with reference to the drawings.

### First Embodiment

### (Description of System Configuration)

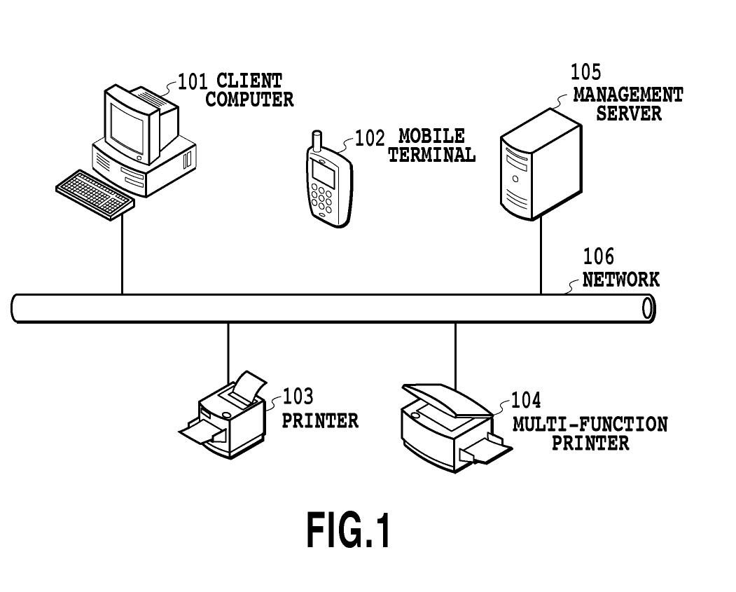

FIG. 1 is a schematic representation showing a configuration of an image forming apparatus management system showing an embodiment of the present invention. In FIG. 1, a client computer 101 is used by a user to generate image data and perform printing. The client computer 101 includes hardware resources to be described later, an operating system (OS), and software resources including a printer driver. Further, the client computer 101 is communicably connected by a predetermined protocol to an image forming apparatus connected to a network 106.

Likewise, a mobile terminal 102 is used by a user to generate image data and perform printing. The mobile terminal 102 includes hardware resources to be described later, an operating system (OS), and software resources including a printer driver. Further, the mobile terminal 102 includes a wireless network interface, and is communicably connected by a predetermined protocol to the image forming apparatus connected to the network 106.

In the embodiment, the client computer 101 and the mobile terminal 102 are collectively called user terminals. A printer 103 gets print data received through the network, and does actual printing on paper, using known printing technology such as electrophotography or ink jet technology. A multi-function printer (MFP) 104 gets print data received through the network, and does actual printing on paper, using known printing technology such as electrophotography or inkjet technology. Also, the multi-function printer 104 has the function of reading a paper document through a scanner and making a copy of the document, or converting the document into image data and sending e-mail with the image data attached thereto or otherwise transmitting the image data. Of course, a printer which does not have the copy function is also applicable.

The printer 103 and the multi-function printer 104 are collectively called the image forming apparatuses. When a power status of the printer 103 or the multi-function printer 104 is changed, a management server 105 receives notification of the change of power status, executes processing of the embodiment, and sends power status notification to the client computer 101 or the mobile terminal 102 to be notified of the power status. Incidentally, the client computer 101, the mobile terminal 102, the printer 103, the multi-function printer 104 and the management server 105 are communicably interconnected by the network 106 using known technology such as Ethernet (which is a registered trademark).

Also, in the embodiment, the management server 105 is provided as a configuration which is separate from the printer 103 and the multi-function printer 104; however, a module having the same function maybe provided internal to each of the printer 103 and the multi-function printer 104. In this case, network communications which occur between the management server 105 and each of the printer 103 and the multi-function printer 104 may be construed as being replaced by passing of data over a system bus or the like.

### (Internal Configuration of Computer)

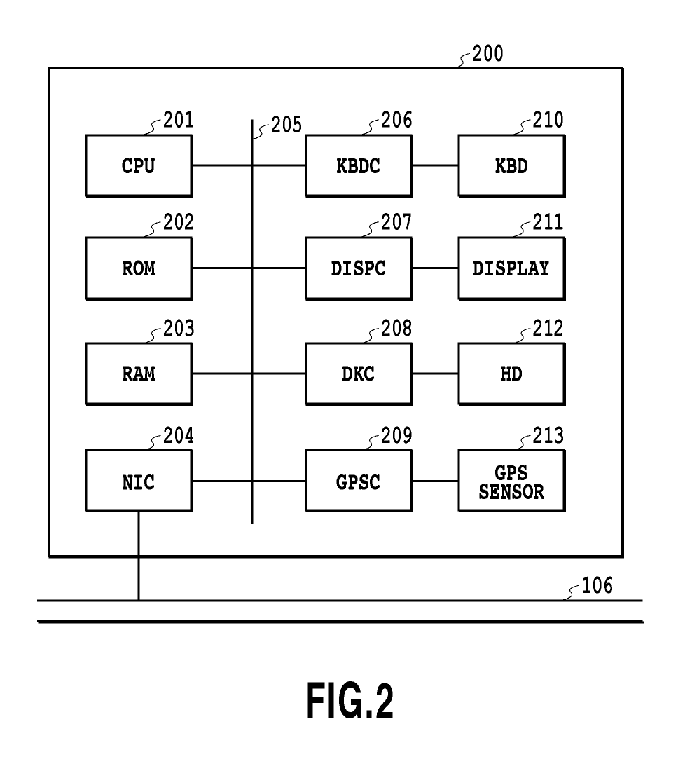

FIG. 2 is a block diagram showing an example of an internal configuration of a general information processing apparatus which forms the client computer 101, the mobile terminal 102 and the management server 105; however, it is needless to say that, in addition, the apparatuses may have their own inherent functions. In FIG. 2, a PC (personal computer) 200, the computer as a whole, includes a CPU (central processing unit) 201 which executes software programs stored in ROM (read only memory) 202 or on an HD (hard disk) 212 as a large-scale storage device or the like. The CPU 201 performs centralized control on individual pieces of hardware connected to a system bus 205.

RAM (random access memory) 203 functions as main memory of the CPU 201, a work area, or the like. A network interface card (NIC) 204 carries out two-way data communications with other nodes through the network 106. A keyboard controller (KBDC) 206 controls a command input from a keyboard (KBD) 210 which the PC is provided with. A display controller (DISPC) 207 controls display of a display module (DISPLAY) 211 formed by a liquid crystal display for example or the like. A disk controller (DKC) 208 controls the hard disk (HD) 212 as a mass storage image forming device. A GPS sensor controller (GPSC) 209 receives a signal from a GPS sensor 213 and performs control.

### (Internal Configuration of Multi-Function Printer)

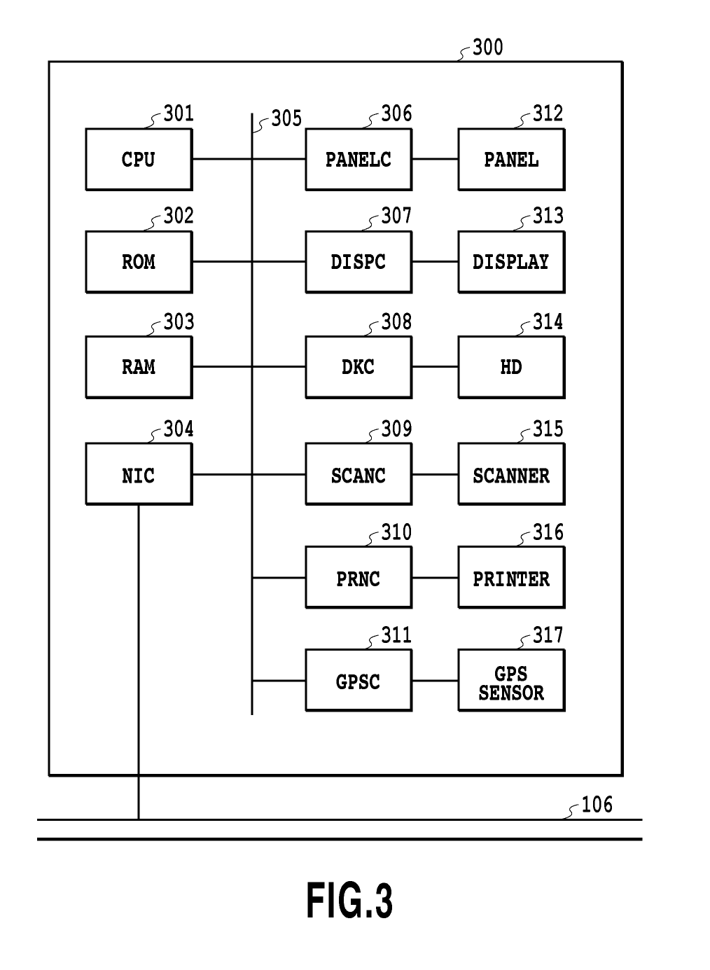

FIG. 3 is a block diagram showing an example of an internal configuration of the multi-function printer 104 shown in FIG. 1. In FIG. 3, a multi-function printer 300 includes a CPU 301 which executes software programs stored in ROM 302 or on an HD 314 as a large-scale storage device such as a hard disk or the like, and the CPU 301 performs centralized control on individual pieces of hardware connected to a system bus 305.

RAM 303 functions as main memory of the CPU 301, a work area, or the like. A network interface card (NIC) 304 carries out data communications with other nodes through the network 106. A panel controller (PANELC) 306 controls a command input from an operation panel (PANEL) 312 which the multi-function printer is provided with. A display controller (DISPC) 307 controls display of a display module (DISPLAY) 313 formed by a liquid crystal display for example or the like.

A disk controller (DKC) 308 controls the hard disk (HD) 314 as a mass storage image forming device. A scanner controller (SCANC) 309 controls an optical scanner apparatus (or a scanner) 315 included in the multi-function printer thereby to perform the reading of paper documents. A printer controller (PRNC) 310 controls a printer apparatus (or a printer) 316 included in the multi-function printer thereby to do actual printing on paper, using known printing technology such as electrophotography or ink jet technology. A GPS sensor controller (GPSC) 311 receives a signal from a GPS sensor 317 and performs control.

Incidentally, an internal configuration of the printer 103 shown in FIG. 1, although not described in detail here, may be construed as the internal configuration of the multi-function printer 104 described above, exclusive of the scanner controller 309 and the optical scanner apparatus 315. The printer 103 may be of a configuration obtained by further removing the panel controller (PANELC) 306, the operation panel (PANEL) 312, the display controller (DISPC) 307 and the display module (DISPLAY) 313 and others from the internal configuration of the multi-function printer 104.

### (Functional Configuration of Computer)

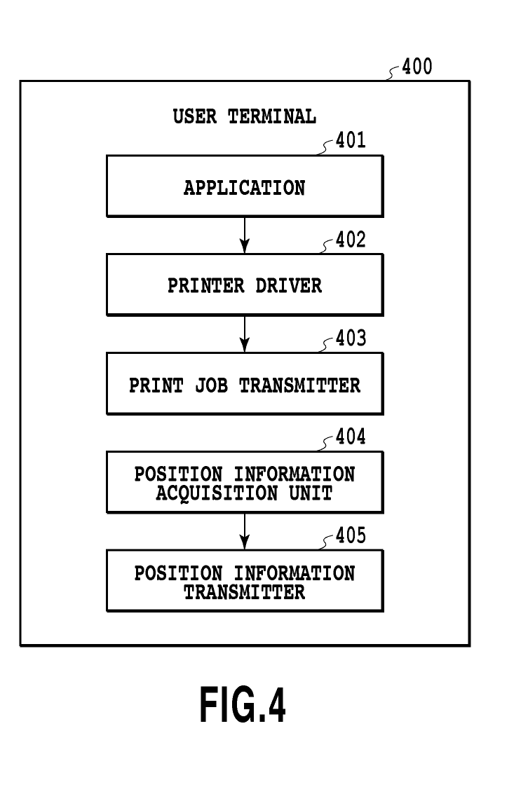

FIG. 4 is a block diagram showing an example of a functional configuration of an overall computer 400 as the client computer 101 and the mobile terminal 102 shown in FIG. 1. A print application 401 for performing a print command transmits a drawing command or the like to a printer driver 402 thereby to perform the print command. The printer driver 402 converts the drawing command or the like received from the print application 401 into print data which is interpretable with the multi-function printer, specifically PDL (Page Description Language). Further, the printer driver 402 creates a print job by appending job owner information by assigning a user ID (identification) of a user who has operated the print application 401 to give a command to print, and transmits the print job to a print job transmitter 403. Also, a print job containing position information acquired from a position information acquisition unit 404 may be created.

The print job transmitter 403 transmits the print job received from the printer driver 402 to the multi-function printer 104. The position information acquisition unit 404 acquires computer position information (e.g. latitude, longitude, altitude, etc.) from the GPS sensor 317. Upon detection of a change in position information, a position information transmitter 405 transmits the position information to the management server 105. Also, under normal conditions, even if there is no change in position information, the position information transmitter 405 transmits position information to the management server 105 at regular intervals.

### (Functional Configuration of Management Server)

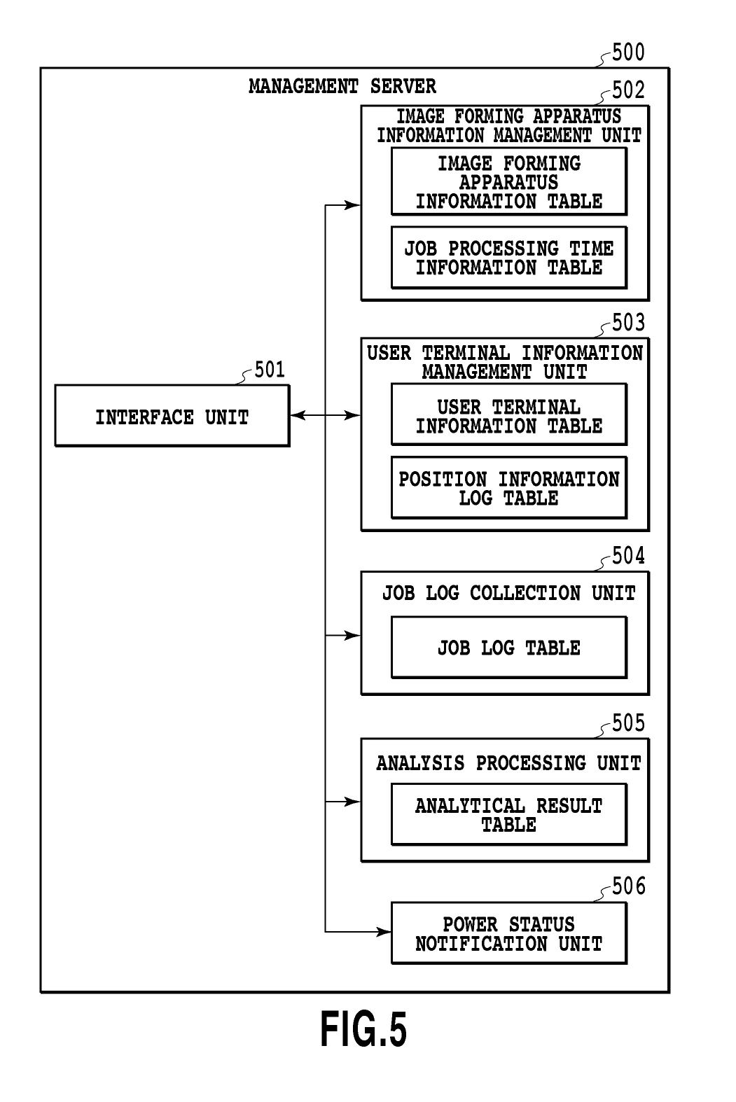

FIG. 5 is a block diagram showing an example of a functional configuration of the management server 105 shown in FIG. 1. In FIG. 5, an overall management server 500 includes an interface unit 501 which carries out communications with the client computer 101, the printer 103 and the multi-function printer 104 via the network 106 through the NIC 204 shown in FIG. 2.

An image forming apparatus information management unit 502 holds information related to the image forming apparatuses. The image forming apparatus information management unit 502 acquires information such as position information from the printer 103 and the multi-function printer 104 via the interface unit 501, and keeps records of their positions. A user terminal information management unit 503 holds information related to the user terminals. The user terminal information management unit 503 for keeping records of the positions of the user terminals or doing the like acquires information from the client computer 101 or the mobile terminal 102 via the interface unit 501. Also, the user terminal information management unit 503 receives position information transmitted from the client computer 101 or the mobile terminal 102, and creates and keeps a position information log.

A job log collection unit 504 collects job log information managed by a job log management unit 610 of the printer 103 or the multi-function printer 104 via the interface unit 501 at regular intervals, and keeps a record of jobs. Also, the printer 103 or the multi-function printer 104 may transmit job log information so that the job log collection unit 504 keeps a record of the job log information at the time of receipt of the job log information. An analysis processing unit 505 analyzes the number of pages printed by the image forming apparatus, the number of sheets of paper, a user terminal which uses the image forming apparatus, average waiting time for the image forming apparatus, or the like, based on the job log information. As a result of this analysis, it is possible to get a grasp on which user terminal usually uses each image forming apparatus, thus enabling proper assignment without determining an image forming apparatus to be used simply from a distance.

A power status notification unit 506 detects a change of power status of an image forming apparatus, and sends notification to an appropriate user terminal which is likely to use the image forming apparatus. The power status notification unit 506 detects the change of power status by receiving power status change notification from the printer 103 or the multi-function printer 104 via the interface unit 501. Further, the power status notification unit 506 sends power status notification to the appropriate client computer 101 or the appropriate mobile terminal 102 via the interface unit 501, based on the power status change notification.

### (Functional Configuration of Multi-Function Printer)

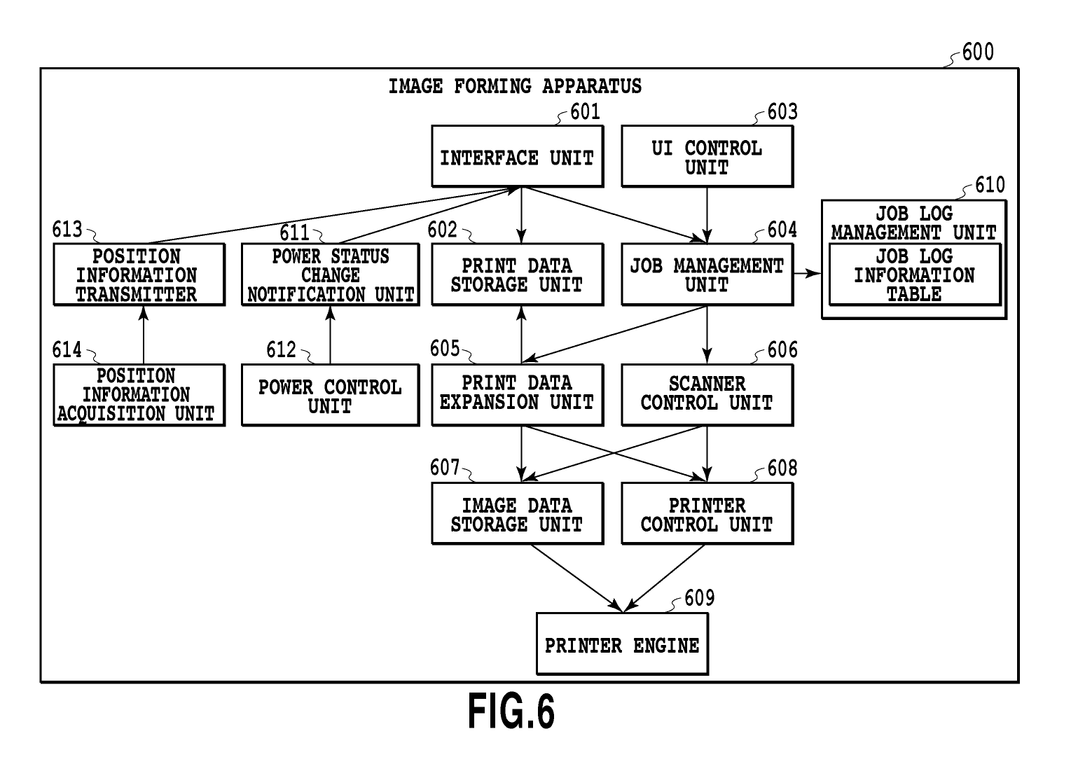

FIG. 6 is a block diagram showing an example of a data processing configuration of the multi-function printer 104 shown in FIG. 1. In FIG. 6, an overall multi-function printer 600 is connected to the network 106 as given below, and includes an interface unit 601 which receives a print job from the client computer 101. A print data storage unit 602 temporarily stores print job data. A UI (user interface) control unit 603 controls the operation panel (PANEL) 312 via the panel controller (PANELC) 306, and accepts a copy command or a scan/send command which a user gives to the multi-function printer 104. A job management unit 604 analyzes the print job received from the client computer 101, acquires output attribute information such as a user name, the number of copies printed, or color printing, and manages the output attribute information in conjunction with the date and time of start of the job, as job information.

A print data expansion unit 605 acquires print data from the print data storage unit 602 and performs image generation processing thereby to generate image data on the RAM 303, according to job information stored in the job management unit 604. A scanner control unit 606 controls the scanner controller 309 thereby to perform scanning on a paper document and create the generated image data. Incidentally, when an ADF (automatic document feeder), an RDF (reverse document feeder) or the like is connectable as a document feeder, the scanner control unit 606 controls document feeding and document ejection from the ADF or the RDF. Also, the scanner control unit 606, if reading a two-sided document, may perform reverse control on the document.

An image data storage unit 607 temporarily stores the image data generated by the print data expansion unit 605 and the scanner control unit 606. A printer control unit 608 controls a printer engine 609 thereby to cause the printer engine 609 to perform printing of the image data stored in the image data storage unit 607. The printer engine 609 actually prints out the image data stored in the image data storage unit 607, on media such as printing paper, by using known printing technology such as electrophotography or ink jet technology.

The job log management unit 610 manages job log information. Upon completion of a job, the job management unit 604 transmits its managed job information as the job log information to the job log management unit 610, and then the job log management unit 610 keeps the job log information. The job log management unit 610 transmits a job log in response to a request from the management server 105. A power control unit 612 controls a power supply of the multi-function printer 104 thereby to manage power status conditions such as normal mode, power saving mode (or operating mode), and a power-off state. The power control unit 612 can control the image forming apparatus so that the apparatus switches from one power status to another, according to various conditions. For example, when in the normal mode the multi-function printer 104 is not operated during a certain period of time and the receiving of a print job, the receiving of a facsimile, the receiving of a command from the network or the like does not take place, the power control unit 612 switches the multi-function printer 104 into the power-off state or the power saving mode. Also, the power control unit 612 changes the power status in response to a power status change request to perform switching to the power-off state or the power saving mode or do the like, which is sent from the management server 105. Further, the power control unit 612 may perform the switching to the power-off state or the power saving mode at a preset time. When changing the power status, the power control unit 612 notifies a power status change notification unit 611 of a change of power status.

The power status change notification unit 611 receives notification from the power control unit 612 and sends notification of the power status to the management server through the interface unit 601. Also, the power status change notification unit 611 may notify the power status at regular intervals. Specifically, the power status change notification informs the management server of “active,” “switching to power saving,” “cancellation of power saving,” “power-on,” “power-off” or other status or a change of status. Notification of the “active” status indicates that the multi-function printer is operating in the normal mode. Notification of the “switching to power saving” status is provided when the multi-function printer switches from the normal mode to the power saving mode. Notification of the “cancellation of power saving” status is provided when the multi-function printer switches from the power saving mode to the normal mode. Notification of the “power-on” status (hereinafter called power-on change notification) is provided when the multi-function printer in the power-off state is powered on thereby to switch to the normal mode. Notification of the “power-off” status (hereinafter called power-off change notification) is provided when the multi-function printer switches to the power-off state. The power-off change notification may contain the actual time it takes for the image forming apparatus to switch to the power-off state, thereby enabling the management server 500 to calculate the time it takes for each image forming apparatus to reach the power-off state. Incidentally, an original communications protocol or a publicly defined communications protocol may be used as a method for sending notification through the interface unit 601. Also, notification may be sent only to the management server 105 previously specified, or multicast or broadcast communication may also be used to send notification to plural targets.

A position information acquisition unit 614 acquires multi-function printer position information (e.g. latitude, longitude, altitude, etc.) from the GPS sensor 317. A position information transmitter 613 transmits the image forming apparatus position information to the management server 105 in response to a position information acquisition request from the management server 105; however, the position information transmitter 613 may transmit position information to the management server 105 at the time of detection of occurrence of a change in the position information. Also, the position information transmitter 613 may transmit position information at regular intervals. Incidentally, it will be understood that the configuration of the printer 103 having no scanner, although here omitted, may be construed as the configuration of the multi-function printer 104 described with reference to FIG. 6, exclusive of the scanner control unit 606, the UI control unit 603, and so on, and therefore the configuration of the printer 103 may be considered to be the same as that of the multi-function printer 104.

### (Image Forming Apparatus Information Table)

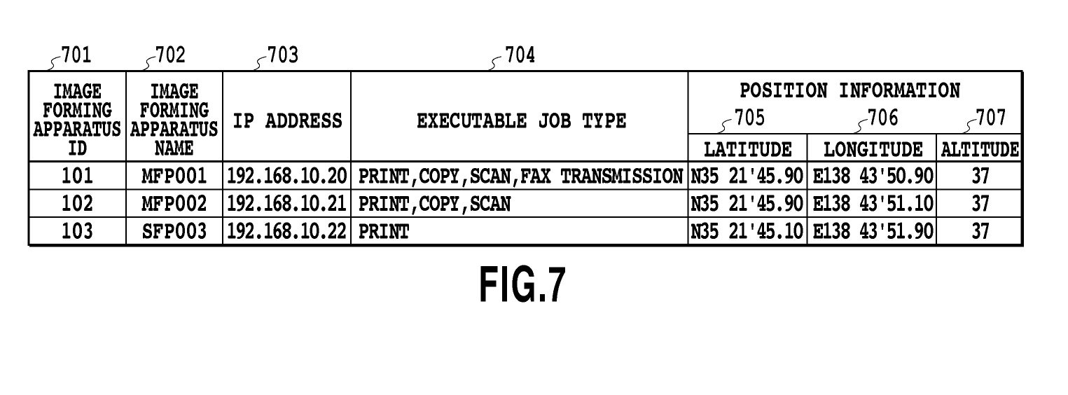

FIG. 7 is a table showing an example of an image forming apparatus information table included in the image forming apparatus information management unit 502 shown in FIG. 5. In FIG. 7, a column 701 indicates image forming apparatus IDs, and indicates the IDs which uniquely identify the image forming apparatuses in the system. A column 702 indicates image forming apparatus names of the image forming apparatuses in their respective corresponding rows. A column 703 indicates IP (Internet Protocol) addresses of the image forming apparatuses in their respective corresponding rows. A column 704 indicates types of jobs which are executable by the image forming apparatuses in their respective corresponding rows.

Columns 705 to 707 indicate position information on the image forming apparatuses in their respective corresponding rows. The image forming apparatus position information can be acquired from the multi-function printer via the network by use of the interface unit 501 by the image forming apparatus information management unit 502. The column 705 indicates the latitudes of the image forming apparatuses in their respective corresponding rows. The column 706 indicates the longitudes of the image forming apparatuses in their respective corresponding rows. The column 707 indicates the altitudes of the image forming apparatuses in their respective corresponding rows. These information items managed by the image forming apparatus information management unit 502 enable grasping the types of executable jobs, the position information, and the like, for each of the image forming apparatuses.

### (Job Processing Time Information Table)

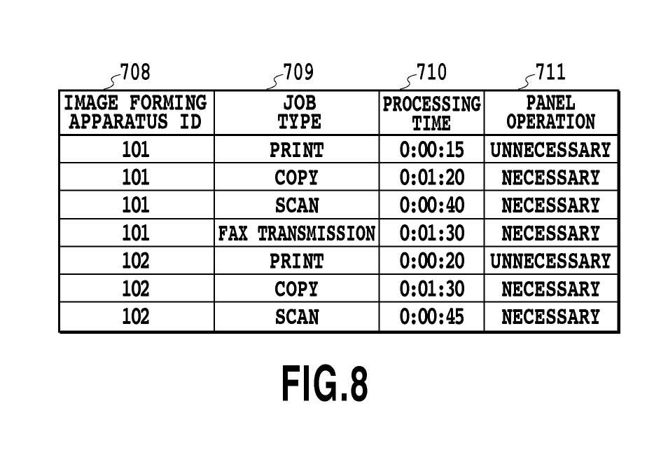

FIG. 8 is a table showing an example of a job processing time information table for the image forming apparatuses, included in the image forming apparatus information management unit 502 shown in FIG. 5. The job processing time information table is the table which holds information about the time required for job processing for each job type, information as to whether or not user's panel operation is necessary, and the like. The time required for job processing refers to the time required between the instant when a user submits a job and the instant when the image forming apparatus terminates the job. The information in the job processing time information table is preset by an administrator. Also, when the image forming apparatus holds the information, the information may be acquired from the image forming apparatus via the network. Further, the information may be calculated by collecting operation logs or the like from the image forming apparatus and analyzing the logs.

In FIG. 8, a column 708 indicates the image forming apparatus IDs, which uniquely identify the image forming apparatuses in the system. A column 709 indicates the job types. The job types refer to the types of jobs processed by the image forming apparatus, and, in the embodiment, the job types include “print” as printing done by a host, “copy, ” “scan, ” “facsimile transmission,” “facsimile reception,” and “box print” for printing documents retained in the multi-function printer; however, the job types are not so limited. Generally, functions to be used, of functions included in the image forming apparatus, vary according to the job type, and therefore the job processing time depends on the job type. For example, the “copy” requires a longer processing time as compared to the mere “print” because of addition of an image reading function, while the “facsimile transmission,” although not involving a print function, is affected by the influence of time for communication with a facsimile on the receiving end. A column 710 indicates the processing time, or the time required for job processing, and it is to be understood that the processing time varies greatly according to the job type. A column 711 indicates whether or not a user needs to (move to the front of the image forming apparatus and) do panel operation in order to process a job. This information on the panel operation, to be described later, is the information used to calculate the time needed for processing, taking into account the moving time it takes for the user to move to the image forming apparatus. These information items managed by the image forming apparatus information management unit 502 enable the management server 105 to calculate the actual time required for job processing for each of the image forming apparatuses.

### (User Terminal Information Table)

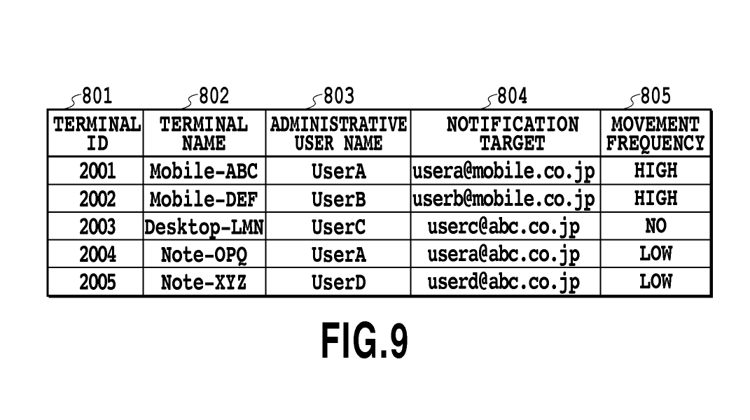

FIG. 9 is a table showing an example of a user terminal information table held in the user terminal information management unit 503 shown in FIG. 5. In FIG. 9, a column 801 indicates terminal IDs, which uniquely identify the user terminals in the system. A column 802 indicates user terminal names. A column 803 indicates administrative user names, and indicates users who manage the user terminals.

A column 804 indicates notification targets, and indicates the notification targets such as e-mail addresses of the user terminals or the administrative users of the user terminals. A column 805 indicates movement frequency, and indicates the movement frequency of the user terminals. Terminals with “no” movement frequency include desktop PCs which are rarely moved. Terminals with “low” movement frequency include notebook PCs which are moved about once every few hours in non-territorial office environments or the like. Terminals with “high” movement frequency include mobile terminals which are frequently moved along with their users who use them.

In the embodiment, the reason for using the movement frequency is that, as later described, evaluation of a distance between the user terminal and the image forming apparatus varies according to the types of terminals having different frequencies of movement (e.g. the desktop PC, the notebook PC, the mobile terminal, etc.). In the case of, for example, the mobile terminal or the like, the terminal may merely be temporarily far away from the image forming apparatus even if the present position of the terminal is far away from the image forming apparatus, and therefore, the terminal cannot be judged as not being a notification target, simply from its present position. In the embodiment, as later described, the most recent range of movement of the user terminal is determined based on the most recent position information log, and, when a position near the image forming apparatus is within the most recent range of movement, a decision is made that the user terminal is very likely to be also currently using the image forming apparatus, so that the user terminal is judged as the notification target. Incidentally, the movement frequency is obtained by analyzing the position information log to be described later. These information items managed by the user terminal information management unit 503 enable grasping the movement frequency of the user terminals, and the like.

### (Position Information Log Table)

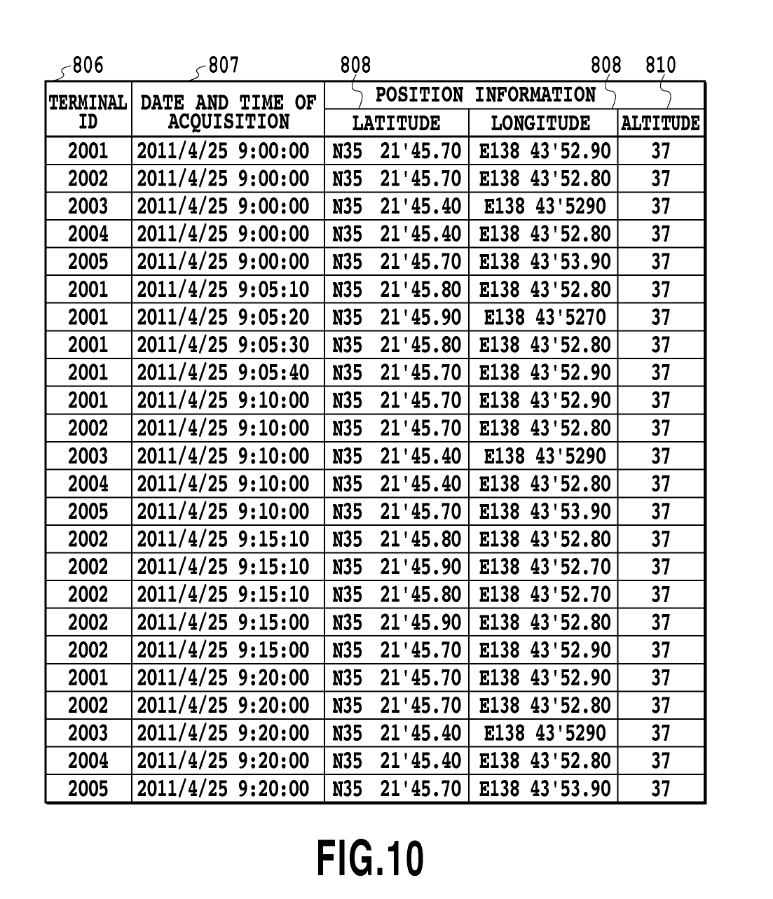

FIG. 10 is a table showing an example of a position information log table included in the user terminal information management unit 503 shown in FIG. 5. The user terminal information management unit 503 keeps position information received from plural user terminals, in conjunction with the date and time of acquisition of the position information, as position information logs, in the position information log table.

In FIG. 10, a column 806 indicates the terminal IDs, which uniquely identify the user terminals in the system. A column 807 indicates the date and time of acquisition, and indicates the date and time of acquisition of position information. Columns 808 to 810 indicate position information on the user terminals in their respective corresponding rows. The column 808 indicates the latitudes of the user terminals in their respective corresponding rows. The column 809 indicates the longitudes of the user terminals in their respective corresponding rows. The column 810 indicates the altitudes of the user terminals in their respective corresponding rows. These information items managed by the user terminal information management unit 503 enable the management server 105 to grasp histories of movement of the user terminals.

### (Job Log Table)

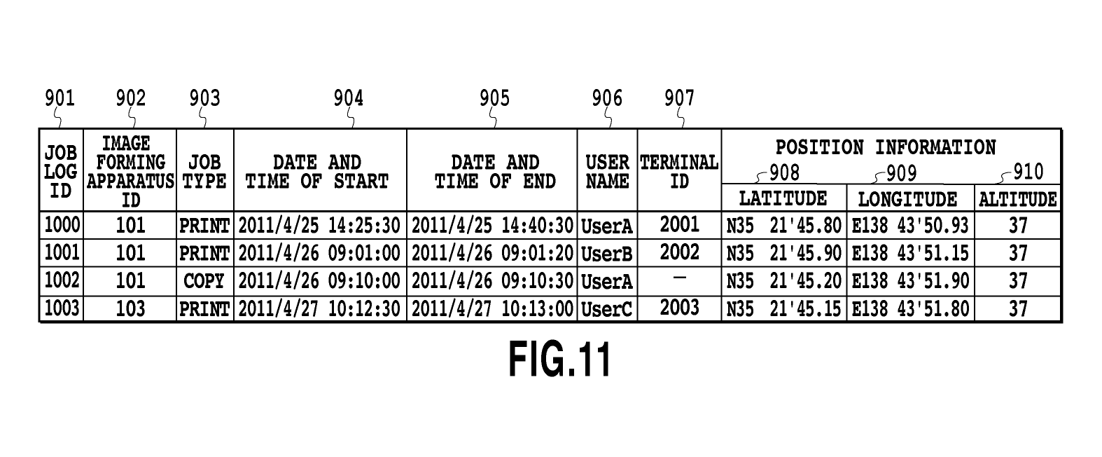

FIG. 11 is a table showing an example of a job log table included in the job log collection unit 504 shown in FIG. 5. The job log collection unit 504 keeps job logs received from plural image forming apparatuses, in the job log table. In FIG. 11, a column 901 indicates job log IDs, which uniquely identify the job logs in the system. A column 902 indicates the image forming apparatus IDs of the image forming apparatuses which have processed jobs. A column 903 indicates the job types. The job types include “print” as printing done by the host, “copy, ” “scan,” “facsimile transmission,” “facsimile reception,” and “box print” for printing documents retained in the multi-function printer. A column 904 indicates the date and time of start of job processing. A column 905 indicates the date and time of end of job processing.

A column 906 indicates the names of users who have executed the jobs. A column 907 indicates the terminal IDs of the user terminals which have executed the jobs. However, the column 907 is blank for the job type, such as the “copy, ” which is not executed by the user terminal. Columns 908 to 910 indicate position information on the user terminals at the time of job execution. When the user terminal creates a print job containing the position information, the position information may be acquired from print job information. Also, the position information may be acquired, and added, from the position information log managed by the user terminal information management unit 503, based on information contained in the start date and time 904, the user name 906, and the terminal ID 907.

The column 908 indicates the latitudes of the user terminals at the time of job execution. The column 909 indicates the longitudes of the user terminals at the time of job execution. The column 910 indicates the altitudes of the user terminals at the time of job execution. These information items enable the management server to determining who has submitted and processed a job, when and where the job has been submitted and processed, and what type of job has been submitted and processed. Also, the job log table may be constructed so as to be created for each of the job types.

### (Analytical Result Table)

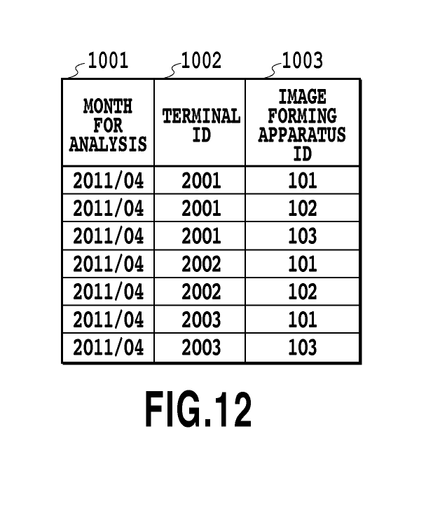

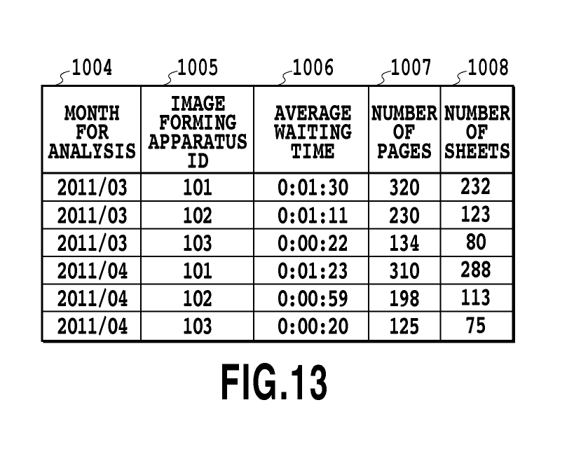

FIGS. 12 and 13 are tables showing examples of analytical result tables included in the analysis processing unit 505 shown in FIG. 5. The analytical result tables are the tables which keep results of analyses performed on information such as job logs collected by the management server 105. The analytical result table of FIG. 12 indicates analytical results of track records of use, and is the table which keeps records of information on the image forming apparatuses having track records of use by the user terminals.

In FIG. 12, a column 1001 indicates months for analysis, and indicates what month the analytical results in their respective corresponding rows have been obtained in. In the embodiment, the analytical results are obtained on a monthly basis; however, analytical results may also be obtained on an annual basis or on a weekly basis according to periods at which calculations are carried out, or the like. A column 1002 indicates the terminal IDs, and indicates which user terminal the analytical results in their respective corresponding rows have been obtained from. A column 1003 indicates the image forming apparatus IDs, and indicates the image forming apparatus IDs of the image forming apparatuses which have been used by the user terminals in the rows corresponding to the months for analysis in their respective corresponding rows.

The analytical result table of FIG. 13 indicates analytical results of average waiting time, and is the table which keeps records of information on the average waiting time for the image forming apparatuses. The average waiting time refers to the time required for one user to wait until a desired image forming apparatus becomes available to the user, when the user wants to use it but cannot use it for the reason that another user is using it, or other. The average waiting time can be calculated by analyzing availability based on job logs or doing the like.

In FIG. 13, a column 1004 indicates months for analysis, and indicates what month the analytical results in their respective corresponding rows have been obtained in. In the embodiment, the analytical results are obtained on a monthly basis; however, analytical results may also be obtained on an annual basis or on a weekly basis according to periods at which calculations are carried out, or the like. A column 1005 indicates the image forming apparatus IDs, and indicates which image forming apparatus the analytical results in their respective corresponding rows have been obtained from. A column 1006 indicates the average waiting time, and indicates the average waiting time for the image forming apparatuses in the rows corresponding to the months for analysis in their respective corresponding rows. Updating of the analytical result tables is performed by the analysis processing unit 505 on a regular basis, such for example as on a month-by-month basis, on an hour-by-hour basis, or on a day-by-day basis.

### (Power Status Notification Process)

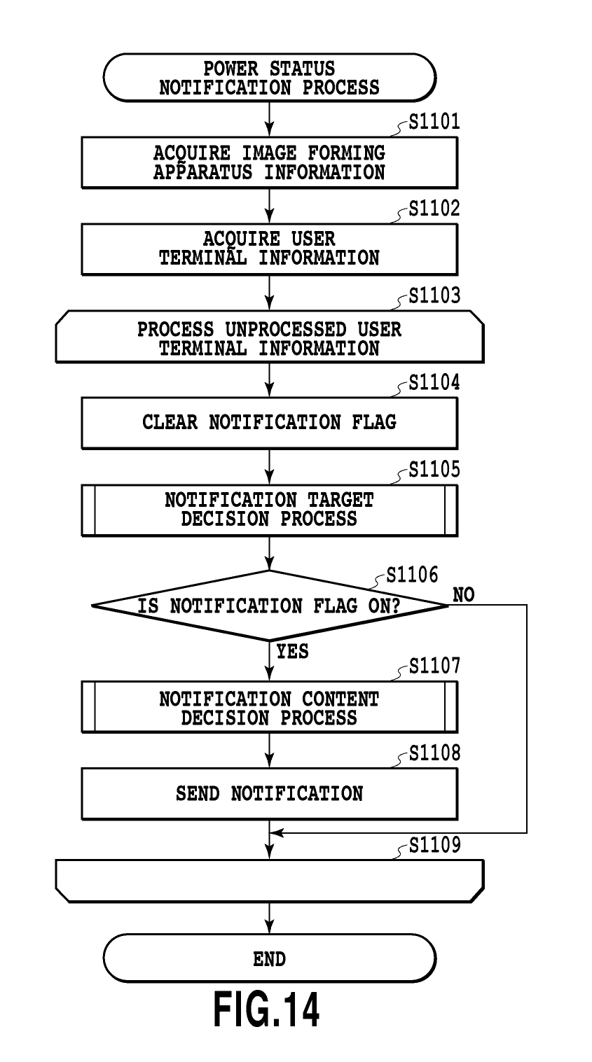

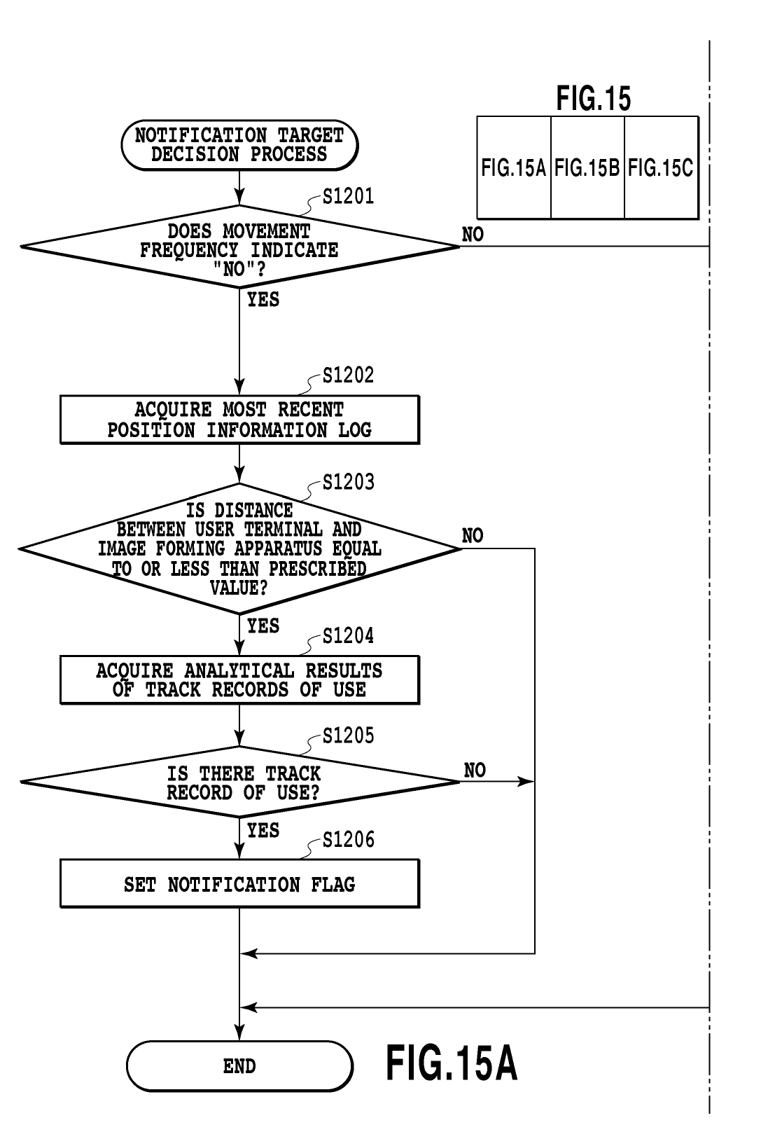

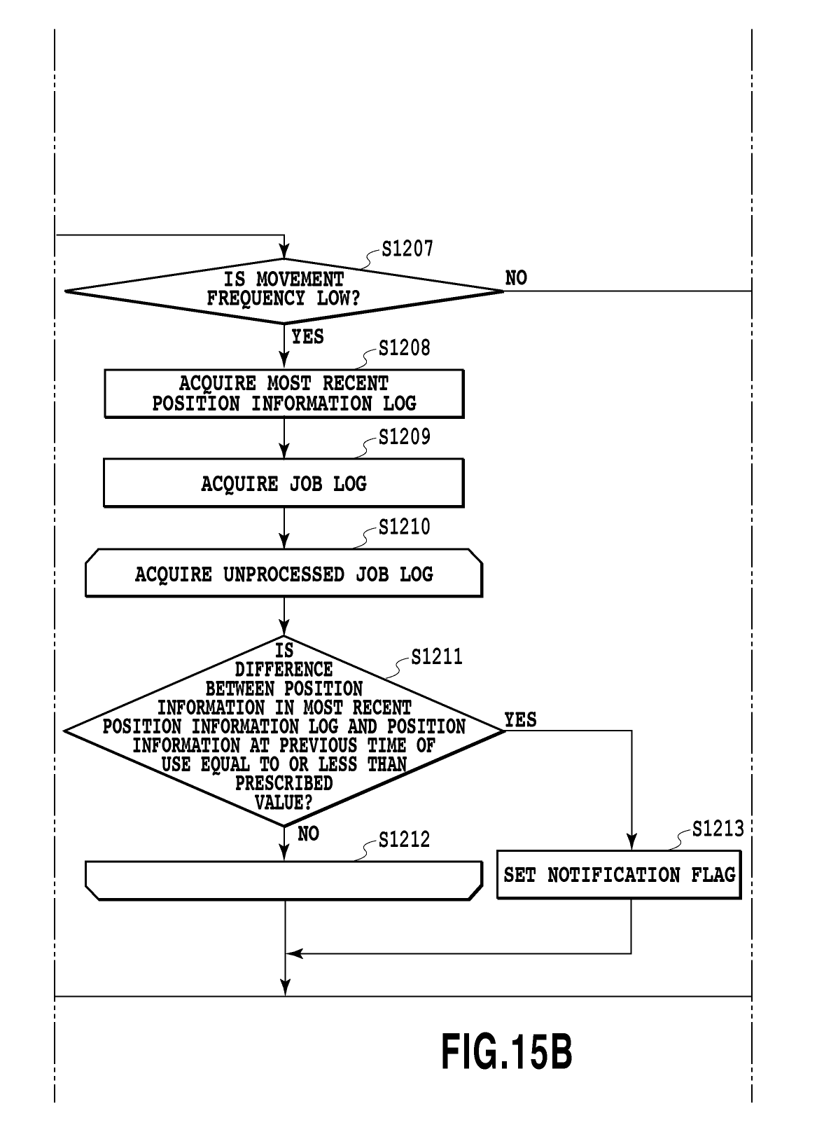

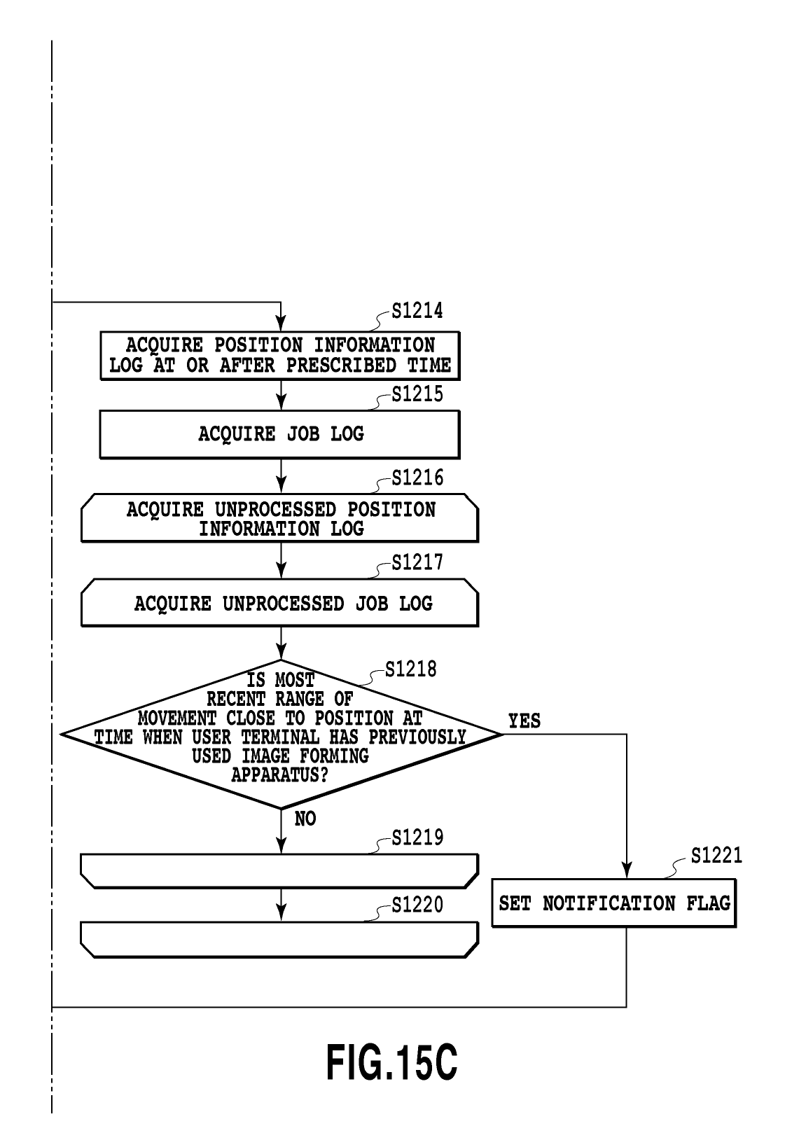

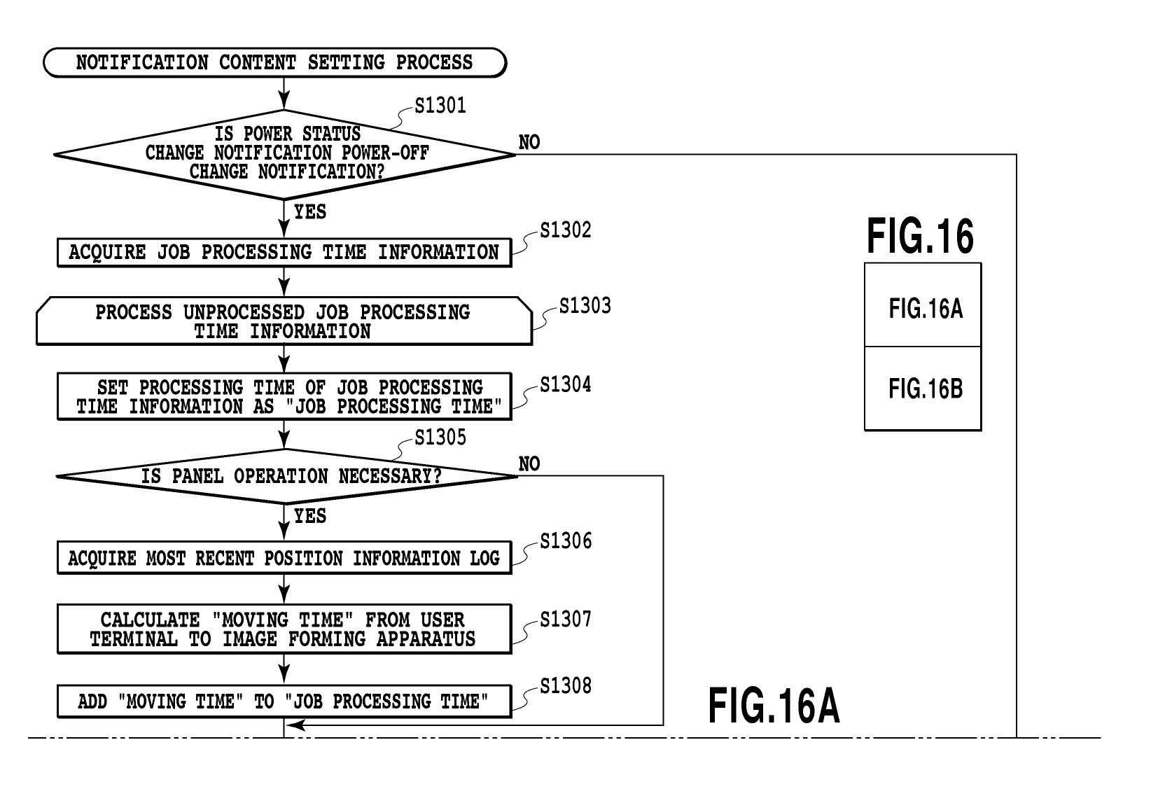

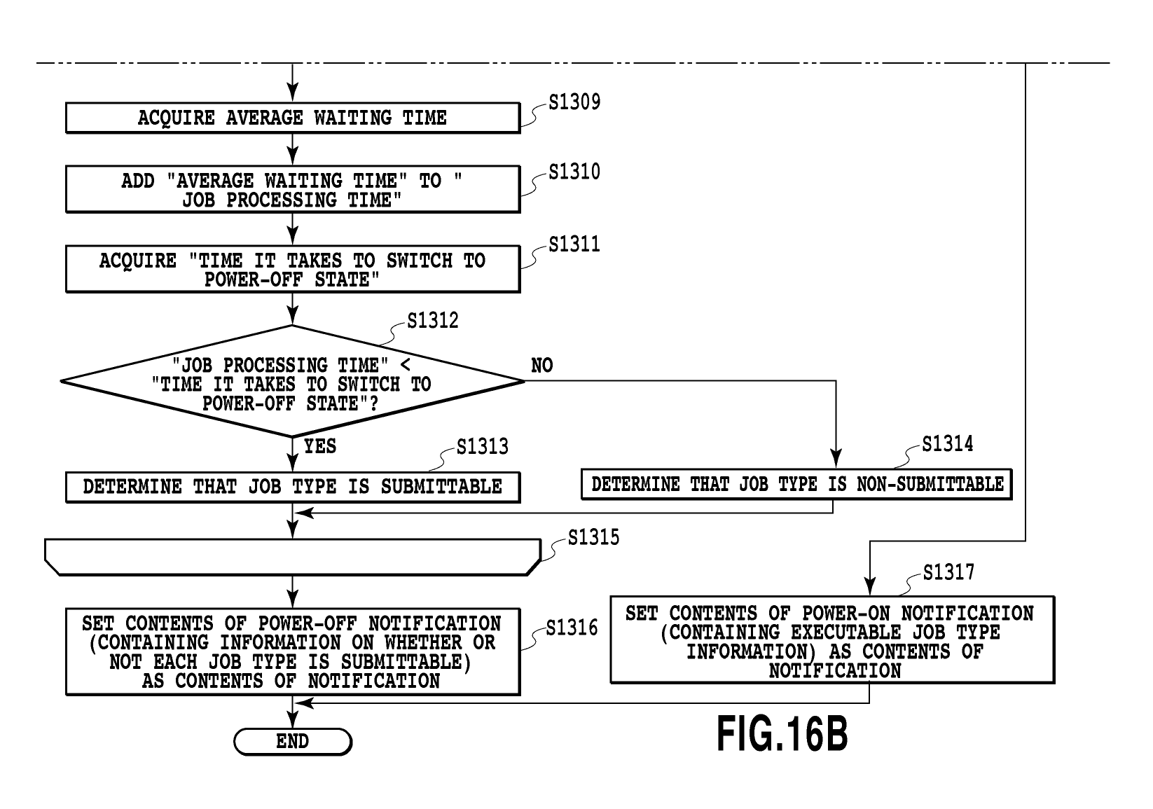

FIG. 14 is a flowchart showing an example of a main procedure for data processing in the information processing apparatus of the embodiment. Specifically, the information processing apparatus of the embodiment executes processing according to the flowchart shown in FIG. 14, while complicated portions of the processing (i.e. steps S1105 and S1107) will be described in detail with reference to flowcharts of FIGS. 15 and 16, respectively. Incidentally, in the embodiment, the management server 105 shown in FIG. 1 acts as the information processing apparatus to perform the processing. Also, upon receipt of power status change notification (i.e. power-on change notification and power-off change notification) from the image forming apparatus, the management server 105 executes the power status notification process. Depending on the system, however, the power status notification process may be executed at regular intervals, or may be executed by other triggers.

Also, steps S1101 to S1109 are implemented by the CPU 201 loading control programs from the HD 212, the ROM 202 or the like into the RAM 203 and executing the programs.

When the power status notification process is started, at step S1101 the power status notification unit 506 acquires image forming apparatus information on an image forming apparatus as a source of received power status change notification, from image forming apparatus information kept in the image forming apparatus information management unit 502. Then, at step S1102, the power status notification unit 506 acquires all user terminal information kept in the user terminal information management unit 503. After that, the power status notification unit 506 repeats a flow of the processing between steps S1104 and S1109 for unprocessed user terminal information, for each individual piece of the acquired user terminal information (at step S1103). Therefore, the processing is repeated until all the acquired user terminal information is processed.

First, at step S1104, the power status notification unit 506 clears a notification flag to initialize it. Thereby, a corresponding user terminal does not become a notification target unless the notification flag is set by processing to be performed later. At step S1105, the power status notification unit 506 performs a notification target decision process, specifically a process for determining whether or not a user terminal corresponding to information being processed is an appropriate notification target for power status notification. Details of the notification target decision process will be described later. Here, the appropriate notification target, although varying depending on the system, as employed in the embodiment, refers to a user terminal which is likely to usually use the image forming apparatus which has sent the power status change notification. When as a result of the process of step S1105 a decision is made that the user terminal is the appropriate notification target, the notification flag is set to “ON”.

When as a result of the process of step S1105 a decision is made as to whether or not to send the power status notification, at step S1106 the power status notification unit 506 determines whether or not the notification flag is on. Here, when the power status notification unit 506 determines that the notification flag is on, the processing goes to step S1107, where a decision is made on the contents of notification to be provided to the user terminal; however, details of a notification content setting process will be described later. Meanwhile, when the power status notification unit 506 determines that the notification flag is not on (i.e. is off), the processing goes to step S1109, where a decision is made as to whether or not user terminal information which has not yet undergone the processing of steps S1104 to S1108 is present, and, when the user terminal information which has not yet undergone the processing is present, the processing returns to step S1103 and is repeated. When the notification flag is on, at step S1108 the power status notification unit 506 sends the power status notification to the user terminal for which the processing is now being performed, specifically the notification target 804 of the user terminal information. When the processing of steps S1104 to S1108 is finished for one user terminal as described above, if at step S1109 the power status notification unit 506 determines that the user terminal information which has not yet undergone the processing of steps S1104 to S1108 is present, the processing returns to step S1103 and is repeated. Meanwhile, when the power status notification unit 506 determines that the user terminal information which has not yet undergone the processing of steps S1104 to S1108 is absent, the process is brought to an end.

### (Notification Target Decision Process)

The main processing of the embodiment has been described above, and then, description will be given below with regard to processing by which the embodiment is characterized, detailed description of which has been avoided. FIG. 15 is a flowchart showing an example of a detailed procedure for the notification target decision process executed at step S1105 shown in FIG. 14, in the information processing apparatus of the embodiment. The notification target decision process involves determining whether or not the user terminal as a processing target is the notification target, based on the movement frequency 805 of the user terminal, specifically according to whether the user terminal is the desktop PC, the notebook PC, or the mobile terminal. Incidentally, steps S1201 to S1221 are implemented by the CPU 201 loading control programs from the HD 212, the ROM 202 or the like into the RAM 203 and executing the programs.

After initialization of the notification flag at step S1104, when the notification target decision process is started, at step S1201 the power status notification unit 506 makes a type decision as to whether or not the movement frequency 805 of user terminal information being processed indicates “no.” Here, when the power status notification unit 506 determines that the movement frequency 805 indicates “no,” the processing goes to step S1202, where, from then on, a decision is made as to whether or not the user terminal is the notification target on condition that the user terminal be the desktop PC. Meanwhile, when the power status notification unit 506 determines that the movement frequency 805 does not indicate “no,” the processing goes to step S1207.

When a decision is made that the user terminal is the desktop PC, at step S1202 the power status notification unit 506 acquires the most recent position information log of the user terminal for which the processing is being performed, from the position information logs kept in the user terminal information management unit 503. At step S1203, the power status notification unit 506 calculates a distance between the user terminal and the image forming apparatus, based on the user terminal position information acquired at step S1202 and the image forming apparatus position information acquired at step S1101, and determines whether or not the calculated distance is equal to or less than a prescribed value. The prescribed value, which indicates the range of sending of power status change notification, is preset by the administrator or the like. For example, a decision is made that the user terminal within a radius of 20 meters from the image forming apparatus is very likely to be using the image forming apparatus, and thus, the user terminal is judged as the appropriate notification target to which the power status notification is to be sent. In this case, the prescribed value is set to 20 meters; however, it is not so limited but may be varied as appropriate according to use conditions or the like. Here, when the power status notification unit 506 determines that the distance between the user terminal and the image forming apparatus is equal to or less than the prescribed value, the processing goes to step S1204, where a decision is made as to whether or not the image forming apparatus has a track record of use. At step S1205, the power status notification unit 506 determines whether or not the image forming apparatus for which the processing is being performed has a track record of use, from analytical results of track records of use acquired at step S1204. Here, when the power status notification unit 506 determines that the image forming apparatus for which the processing is being performed has a track record of use, the processing goes to step S1206. Meanwhile, when the power status notification unit 506 determines that the image forming apparatus for which the processing is being performed has no track record of use, the process is brought to an end. In other words, when the user terminal, even at a short distance from the image forming apparatus, is using a different image forming apparatus for some reason or other, a decision is made as to whether or not the user terminal is the notification target, taking such circumstances into consideration. When at step S1205 a decision is made that the image forming apparatus has a track record of use, at step S1206 the power status notification unit 506 sets the notification flag to “ON”, and brings the process to an end. Meanwhile, when the power status notification unit 506 determines that the distance between the user terminal and the image forming apparatus is not equal to or less than the prescribed value, the process is brought to an end.

At step S1207, the power status notification unit 506 determines whether or not the movement frequency 805 of the user terminal information being processed is “low,” specifically whether or not the user terminal is the notebook PC. Here, when the power status notification unit 506 determines that the movement frequency 805 is “low,” the processing goes to step S1208. At step S1208, the power status notification unit 506 acquires the most recent position information log of the user terminal for which the processing is being performed, from the position information logs kept in the user terminal information management unit 503. Meanwhile, when the power status notification unit 506 determines that the movement frequency 805 is not “low,” the processing goes to step S1214.

At step S1209, the power status notification unit 506 acquires a job log of the user terminal for which the processing is being performed, from the job logs kept in the job log collection unit 504, and executes the following processing for each of jobs which have already been executed. The power status notification unit 506 repeats the processing of a flow of step S1211 for all the already executed jobs contained in the acquired job log, and, upon detection of the absence of unprocessed jobs, the processing is brought to an end.

Then, at step S1211, the power status notification unit 506 determines whether or not a difference between the user terminal position information acquired at step S1208 and the position information in the job log acquired at step S1209 satisfies certain conditions. For example, the certain conditions maybe such that, when a distance between the present position of the user terminal and the position of the user terminal at the time when it has previously used the image forming apparatus is not more than a prescribed value, the user terminal is judged as the notification target. As employed here, the prescribed value refers to the value indicating whether or not the present and previous positions of the user terminal are close to each other, which is preset by the administrator or the like. For example, when the present position of the user terminal is within a radius of 5 meters from the position of the user terminal at the time when it has previously used the image forming apparatus, a decision is made that the user terminal is very likely to be also currently using the image forming apparatus, and thus, the user terminal is judged as the notification target to which the power status notification is to be provided. In this case, the prescribed value is set to 5 meters but is not so limited. Here, when the power status notification unit 506 determines that the difference between the user terminal position information and the position information in the job log is equal to or less than the prescribed value, the processing goes to step S1213, where the notification flag is set to “ON”, or equivalently, the user terminal is judged as the appropriate notification target.

Meanwhile, when the power status notification unit 506 determines that the difference between the user terminal position information and the position information in the job log is not equal to or less than the prescribed value, the processing goes to step S1212, where the above processing is executed for an unprocessed job, and the processing is performed on all jobs in the acquired job log. Specifically, at step S1212, the power status notification unit 506 determines whether or not a job log which has not yet undergone the processing of step S1211 is present, and, when a decision is made that a job which has not yet undergone the processing is present, the processing returns to step S1211 and is repeated. Meanwhile, when the power status notification unit 506 determines that a job which has not yet undergone the processing of steps S1210 to S1212 is absent, the process is brought to an end.

At step S1214, the power status notification unit 506 acquires a position information log of the user terminal for which the processing is being performed, at or after a prescribed time, from the position information logs kept in the user terminal information management unit 503. The prescribed time refers to a value used for determination of the most recent range of movement of the user terminal with high movement frequency, specifically the mobile terminal in the embodiment, and the value is preset by the administrator or the like. For example, the prescribed time is set to 1 hour before the present time, as the value taken as the most recent time. Then, at step S1215, the power status notification unit 506 acquires a job log of the user terminal for which the processing is being performed, from the job logs kept in the job log collection unit 504. At step S1216, the power status notification unit 506 executes the processing of steps S1217 to S1219 for unprocessed position information contained in the position information log acquired at step S1214, with the unprocessed position information acting as a comparison target.

At step S1217, the power status notification unit 506 executes the processing of step S1218 for an unprocessed job log contained in the job log acquired at step S1215, with the unprocessed job log acting as a comparison target. At step S1218, the power status notification unit 506 determines whether or not a difference between the user terminal position information used as the comparison target at step S1216 and the position information in the job log used as the comparison target at step S1217 is equal to or less than a prescribed value. When the power status notification unit 506 determines that the difference between the user terminal position information and the position information in the job log is equal to or less than the prescribed value, the processing goes to step S1221, where the power status notification unit 506 sets the notification flag to “ON” and brings the process to an end. As employed here, the prescribed value refers to the value which defines a distance between the most recent position of the user terminal and the position of the user terminal at the time when it has previously used the image forming apparatus, and the value is used to determine whether or not the user terminal is the appropriate notification target. In other words, the prescribed value refers to the value indicating whether or not the present and previous positions of the user terminal are close to each other, which is preset by the administrator or the like. For example, when the most recent position of the user terminal is within a radius of 5 meters from the position of the user terminal at the time when it has previously used the image forming apparatus, a decision is made that the user terminal is very likely to also currently use the image forming apparatus, and thus, the user terminal is judged as the notification target to which the power status change notification is to be provided. In this case, the prescribed value is set to 5 meters.

However, the user terminal with high movement frequency, specifically the mobile terminal or the like, may merely be temporarily far away from the image forming apparatus even if the present position of the terminal is far away from the image forming apparatus. Therefore, the most recent range of movement of the user terminal is determined based on the most recent position information log, and, when a position near the position of the user terminal at the time when it has previously used the image forming apparatus is within the most recent range of movement, a decision is made that the user terminal is very likely to also currently use the image forming apparatus, and thus, the user terminal is judged as the notification target to which the power status notification is to be provided.

Meanwhile, when the power status notification unit 506 determines that the difference between the user terminal position information and the position information in the job log is not equal to or less than the prescribed value, the processing goes to step S1219, where a decision is made as to whether or not a job which has not yet undergone the processing of step S1218 is present. Here, when the power status notification unit 506 determines that the job which has not yet undergone the processing of step S1218 is present, the processing returns to step S1217 and is repeated. Meanwhile, when the power status notification unit 506 determines that the job which has not yet undergone the processing of step S1218 is absent, the processing goes to step S1220, where a decision is made as to whether or not position information which has not yet undergone the processing of steps S1217 to S1219 is present. Here, when the power status notification unit 506 determines that the position information which has not yet undergone the processing of steps S1217 to S1219 is present, the processing returns to step S1216 and is repeated. Meanwhile, when the power status notification unit 506 determines that the position information which has not yet undergone the processing of steps S1217 to S1219 is absent, the process is brought to an end. The process enables determining an appropriate user terminal for a target of power status notification.

### (Notification Content Setting Process)

FIG. 16 is a flowchart showing an example of a detailed procedure for a notification content decision process executed at step S1107 shown in FIG. 14, in the information processing apparatus of the embodiment. The notification content decision process involves setting the contents of notification to be sent to the user terminal as the notification target, according to the distance between the image forming apparatus and the user terminal. Incidentally, steps S1301 to S1317 are implemented by the CPU 201 loading control programs from the HD 212, the ROM 202 or the like into the RAM 203 and executing the programs.

When at step S1106 a decision is made that the notification flag is on and the notification content setting process is started, at step S1301 the power status notification unit 506 determines whether or not power status change notification received from the image forming apparatus is power-off change notification. When the power status notification unit 506 determines that the power status change notification is the power-off change notification, the processing goes to step S1302. Meanwhile, when the power status notification unit 506 determines that the power status change notification is not the power-off change notification (or is power-on change notification), the processing goes to step S1317, where notification of power-on is provided.

At step S1302, the power status notification unit 506 acquires job processing time information related to the image forming apparatus for which the processing is being performed, from the job processing time information kept in the image forming apparatus information management unit 502. At step S1303, the power status notification unit 506 repeats the processing of steps S1304 to S1314 on pieces of job processing time information on unprocessed job types in the acquired job processing time information on a piece-by-piece basis in series.

At step S1304, the power status notification unit 506 sets the processing time 710 of the job processing time information being processed, as an initial value of criterion job processing time. As later described, the criterion job processing time is used as a reference for determining the contents of notification. At step S1305, the power status notification unit 506 determines whether or not the panel operation 711 of the job processing time information being processed is “necessary.” When the power status notification unit 506 determines that the panel operation 711 is “necessary,” the processing goes to step S1306, where the processing is performed taking into account the moving time it takes for a user to move to the operation panel. Then, at step S1306, the power status notification unit 506 acquires the most recent position information log of the user terminal for which the processing is being performed, from the position information logs kept in the user terminal information management unit 503. At step S1307, the power status notification unit 506 calculates the moving time from the user terminal to the image forming apparatus, based on the user terminal position information acquired at step S1306 and the image forming apparatus position information acquired at step S1101. At step S1308, the power status notification unit 506 adds the time taken to move, calculated at step S1307, to the set criterion job processing time, thereby to determine the criterion job processing time taking into account the time taken to move.

As described above, when a decision is made that the panel operation 711 is “necessary,” the criterion job processing time is determined taking into account the moving time for the user. Meanwhile, when the power status notification unit 506 determines that the panel operation 711 is not “necessary,” the processing goes to step S1309 by bypassing the processing of steps S1306 to S1308 which is performed taking into account the moving time for the user.

At step S1309, the power status notification unit 506 acquires average waiting time for the image forming apparatus for which the processing is being performed, from the analytical results of average waiting time kept in the analysis processing unit 505. At step S1310, the power status notification unit 506 adds the average waiting time acquired at step S1309 to the criterion job processing time thereby to determine the criterion job processing time taking into account the average waiting time. At step S1311 where the processing is performed taking into account the average waiting time, the power status notification unit 506 acquires the time it takes for the image forming apparatus to switch to the power-off state, from the power status change notification received from the image forming apparatus. Upon acquisition of the power-off time, at step S1312 the power status notification unit 506 determines whether or not the criterion job processing time calculated by the processing of steps S1304 to S1310 is less than the time it takes to switch to the power-off state, acquired at step S1311.

When the power status notification unit 506 determines that the criterion job processing time is less than the time it takes to switch to the power-off state, the processing goes to step S1313, where a decision is made that the job type 709 of the job processing time information being processed is the submittable job type and information on the submittable job type is kept. Meanwhile, when the power status notification unit 506 determines that the processing time is not less than the time it takes to switch to the power-off state, the processing goes to step S1314, where a decision is made that the job type 709 of the job processing time information being processed is the non-submittable job type, and information on the non-submittable job type is kept.

Then, at step S1315, the power status notification unit 506 determines whether or not job processing time information on a job type which has not yet undergone the processing of steps S1304 to S1314 is present.

When the power status notification unit 506 determines that the job processing time information on the job type which has not yet undergone the processing of steps S1304 to S1314 is present, the processing returns to step S1304 and is repeated until the processing is completed for job processing time information on all job types. Meanwhile, when the power status notification unit 506 determines that the job processing time information which has not yet undergone the processing of steps S1304 to S1314 is absent, the processing goes to step S1316, where the contents of power-off notification are set as the contents of notification, and the process is brought to an end.

At this time, the power status notification unit 506 sets the contents of power status notification to be sent to the user terminal so that the power status notification contains the information on the submittable job type, determined at step S1313, and the information on the non-submittable job type, determined at step S1314. Meanwhile, at step S1317, the power status notification unit 506 sets the contents of power status notification containing the information on the executable job type 704 of the image forming apparatus information acquired at step S1101. The process enables setting the contents of notification useful to users, such that power-off notification contains information as to whether or not each job type is submittable, or power-on notification contains executable job type information. In accordance with the above, when the image forming apparatus is about to turn off power for purposes of power savings, information as to whether or not each job type is executable can be appropriately sent to the user terminal which is likely to use the image forming apparatus.

### (Power Status Change Notification)

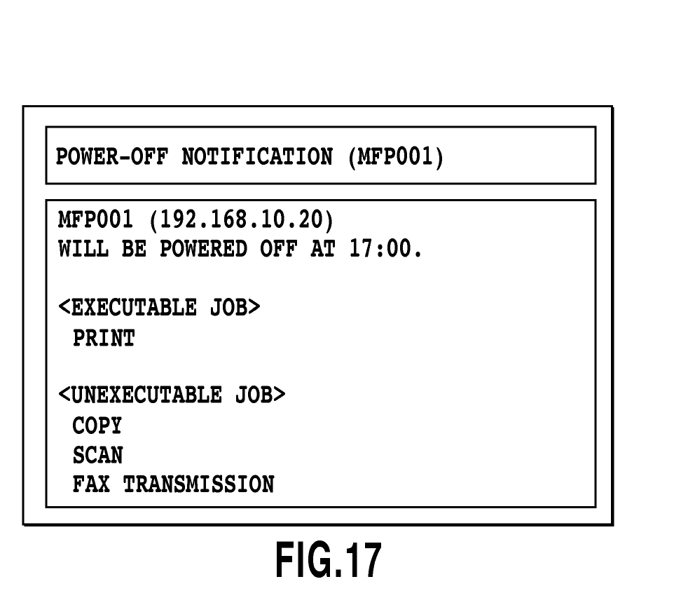

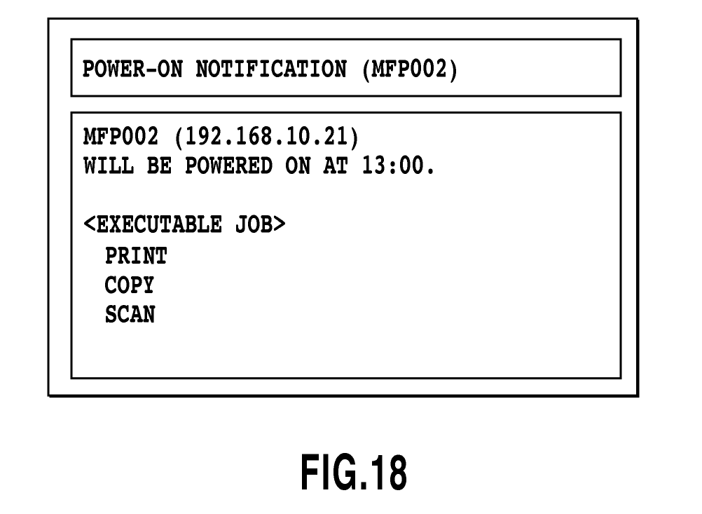

FIG. 17 is a representation showing an example of the contents of power-off notification set at step S1316 shown in FIG. 16. This example illustrates the power-off notification containing the information as to whether or not each job type is submittable. FIG. 18 is a representation showing an example of the contents of power-on notification set at step S1317 shown in FIG. 16. This example illustrates the power-on notification containing the executable job type information.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-194107, filed Sep. 6, 2011, which is hereby incorporated by reference herein in its entirety.

What is claimed is:

1. An image forming apparatus management system including a plurality of image forming apparatuses connected to a network, and a plurality of user terminals each of which uses any one of the plurality of image forming apparatuses connected to the network, comprising:
type decision means for determining the type of each of the user terminals as a notification target, based on movement frequency of the user terminal;
notification target decision means for determining which user terminal is likely to be using each of the image forming apparatuses, based on position information on the user terminal and position information on the image forming apparatus, according to the type of the user terminal determined by the type decision means, and thereby judging the user terminal that is likely to be using the image forming apparatus, as a notification target to be notified of a power status of the image forming apparatus; and
power status notification means for sending power status notification to the user terminal judged as the notification target by the notification target decision means, when the power status of the image forming apparatus is changed.

2. The image forming apparatus management system according to claim 1, further comprising:
image forming apparatus position recording means for recording the position information acquired from the image forming apparatuses;
user terminal position recording means for recording the position information acquired from each of the user terminal, as a position information log;
job recording means for recording job logs acquired from the image forming apparatuses; and
actual usage analysis means for analyzing the job logs, and recording information on an image forming apparatus having a track record of use by the user terminal,
wherein
when the type decision means determines that the user terminal is stationary, if a distance between the present position of the user terminal and the position of any one of the image forming apparatuses is equal to or less than a prescribed value and the image forming apparatus has a track record of use, the notification target decision means determines that the user terminal is the notification target;
when the type decision means determines that the user terminal is low in its movement frequency, if a distance between the present position of the user terminal and the position of the user terminal at the time of using the image forming apparatus is equal to or less than a prescribed value, the notification target decision means determines that the user terminal is the notification target; and
when the type decision means determines that the user terminal is high in its movement frequency, if a distance calculated from the position of the user terminal at or after a prescribed time and the position of the user terminal at the time of using the image forming apparatus is equal to or less than a prescribed value, the notification target decision means determines that the user terminal is the notification target.

3. The image forming apparatus management system according to any one of claims 1 and 2, wherein
the power status notification contains information on a job type submittable before the image forming apparatus reaches a power-off state, and information on a job type non-submittable before that.

4. The image forming apparatus management system according to claim 3, further comprising:
notification content decision means,
wherein, when the power status of the image forming apparatus switches to the power-off state, the notification content decision means determines that a job type is submittable if criterion job processing time required to complete processing of the job is less than the time it takes for the image forming apparatus to switch to the power-off state, the criterion job processing time determined based on preset processing time for each job type.

5. The image forming apparatus management system according to claim 4, wherein
the notification content decision means determines whether or not panel operation of the image forming apparatus is necessary in order to submit each job type, and,
when a decision is made that the panel operation is necessary, the notification content decision means determines the criterion job processing time by adding up the criterion job processing time for the job type and moving time from the user terminal to the image forming apparatus which is calculated based on the present position information of the user terminal and the position information of the image forming apparatus.

6. The image forming apparatus management system according to any one of claims 4 and 5, further comprising:
average waiting time analysis means for analyzing the job logs and calculating average waiting time for the image forming apparatuses,
wherein the notification content decision means determines the criterion job processing time by adding the average waiting time to the criterion job processing time for each job type.

7. The image forming apparatus management system according to claim 1, wherein
the power status notification contains information on a job type executable when the image forming apparatus is in a power-on state.

8. An image forming apparatus management apparatus connected via a network to a plurality of image forming apparatuses and a plurality of user terminals which each use any one of the plurality of image forming apparatuses, comprising:
type decision means for determining the type of each of the user terminals as a notification target, based on movement frequency of the user terminal;
notification target decision means for determining which user terminal is likely to be using each of the image forming apparatuses, based on position information on the user terminal and position information on the image forming apparatus, according to the type of the user terminal determined by the type decision means, and thereby judging the user terminal that is likely to be using the image forming apparatus, as a notification target to be notified of a power status of the image forming apparatus; and
power status notification means for sending power status notification to the user terminal judged as the notification target by the notification target decision means, when the power status of the image forming apparatus is changed.

9. The image forming apparatus management apparatus according to claim 8, further comprising:
image forming apparatus position recording means for recording the position information acquired from the image forming apparatuses;
user terminal position recording means for recording the position information acquired from each of the user terminals, as a position information log;
job recording means for recording job logs acquired from the image forming apparatuses; and
actual usage analysis means for analyzing the job logs, and recording information on an image forming apparatuses having a track record of use by the user terminal,
wherein
when the type decision means determines that the user terminal is stationary, if a distance between the present position of the user terminal and the position of any one of the image forming apparatuses is equal to or less than a prescribed value and the image forming apparatus has a track record of use, the notification target decision means determines that the user terminal is the notification target;
when the type decision means determines that the user terminal is low in its movement frequency, if a distance between the present position of the user terminal and the position of the user terminal at the time of using the image forming apparatus is equal to or less than a prescribed value, the notification target decision means determines that the user terminal is the notification target; and
when the type decision means determines that the user terminal is high in its movement frequency, if a distance calculated from the position of the user terminal at or after a prescribed time and the position of the user terminal at the time of using the image forming apparatus is equal to or less than a prescribed value, the notification target decision means determines that the user terminal is the notification target.

10. An image forming apparatus management method for managing a system including a plurality of image forming apparatuses connected to a network, and a plurality of user terminals which each use any one of the plurality of image forming apparatuses connected to the network, comprising:
a type decision step of determining the type of each of the user terminals as a notification target, based on movement frequency of the user terminal;
a notification target decision step of determining which user terminal is likely to be using each of the image forming apparatuses, based on position information on the user terminal and position information on the image forming apparatus, according to the type of the user terminal determined by the type decision step, and thereby judging the user terminal that is likely to be using the image forming apparatus, as a notification target to be notified of a power status of the image forming apparatus; and
a power status notification step of sending power status notification to the user terminal judged as the notification target by the notification target decision step, when the power status of the image forming apparatus is changed.

11. The image forming apparatus management method according to claim 10, further comprising:
an image forming apparatus position recording step of recording the position information acquired from the image forming apparatuses;
a user terminal position recording step of recording the position information acquired from each of the user terminals, as a position information log;
a job recording step of recording job logs acquired from the image forming apparatuses; and
an actual usage analysis step of analyzing the job logs, and recording information on the image forming apparatuses having track records of use by the user terminals,
wherein,
when the type decision step determines that the user terminal is stationary, if a distance between the present position of the user terminal and the position of any one of the image forming apparatuses is equal to or less than a prescribed value and the image forming apparatus has a track record of use, the notification target decision step determines that the user terminal is the notification target;
when the type decision step determines that the user terminal is low in its movement frequency, if a distance between the present position of the user terminal and the position of the user terminal at the time of using the image forming apparatus is equal to or less than a prescribed value, the notification target decision step determines that the user terminal is the notification target; and
when the type decision step determines that the user terminal is high in its movement frequency, if a distance calculated from the position of the user terminal at or after a prescribed time and the position of the user terminal at the time of using the image forming apparatus is equal to or less than a prescribed value, the notification target decision step determines that the user terminal is the notification target.

12. A recording medium storing a program for an image forming apparatus management apparatus connected via a network to a plurality of image forming apparatuses and a plurality of user terminals which each use any one of the plurality of image forming apparatuses, the program causing the image forming apparatus management apparatus to function as an image forming apparatus management apparatus comprising:
type decision means for determining the type of each of the user terminals as a notification target, based on movement frequency of the user terminal;
notification target decision means for determining which user terminal is likely to be using each of the image forming apparatuses, based on position information on the user terminal and position information on the image forming apparatus, according to the type of the user terminal determined by the type decision means, and thereby judging the user terminal that is likely to be using the image forming apparatus, as a notification target to be notified of a power status of the image forming apparatus; and
power status notification means for sending power status notification to the user terminal judged as the notification target by the notification target decision means, when the power status of the image forming apparatus is changed.

13. The recording medium according to claim 12, causing the image forming apparatus management apparatus to function as the image forming apparatus management apparatus further comprising:
image forming apparatus position recording means for recording the position information acquired from the image forming apparatuses;
user terminal position recording means for recording the position information acquired from each of the user terminals, as a position information log;
job recording means for recording job logs acquired from the image forming apparatuses; and
actual usage analysis means for analyzing the job logs, and recording information on an image forming apparatus having a track record of use by the user terminals,
wherein
when the type decision means determines that the user terminal is stationary, if a distance between the present position of the user terminal and the position of any one of the image forming apparatuses is equal to or less than a prescribed value and the image forming apparatus has a track record of use, the notification target decision means determines that the user terminal is the notification target;
when the type decision means determines that the user terminal is low in its movement frequency, if a distance between the present position of the user terminal and the position of the user terminal at the time of using the image forming apparatus is equal to or less than a prescribed value, the notification target decision means determines that the user terminal is the notification target; and
when the type decision means determines that the user terminal is high in its movement frequency, if a distance calculated from the position of the user terminal at or after a prescribed time and the position of the user terminal at the time of using the image forming apparatus is equal to or less than a prescribed value, the notification target decision means determines that the user terminal is the notification target.
